(19) United States
(12) Patent Application Publication
(10) Pub. No.: US 2026/0142502 A1
(43) Pub. Date: May 21, 2026

(54) ELECTRONIC DEVICE AND METHOD FOR WIRELESS COMMUNICATION

(71) Applicant: SAMSUNG ELECTRONICS CO., LTD., Suwon-si (KR)

(72) Inventors: Taehyun WOO, Suwon-si (KR); Seunghoon OHN, Suwon-si (KR); Boyoung YU, Yongin-si (KR); Seungho LEE, Seoul-si (KR); Hyekyung JEON, Suwon-si (KR)

(73) Assignee: SAMSUNG ELECTRONICS CO., LTD., Suwon-si (KR)

(21) Appl. No.: 19/446,245

(22) Filed: Jan. 12, 2026

Related U.S. Application Data
(63) Continuation of application No. PCT/KR2024/009886, filed on Jul. 10, 2024.

(30) Foreign Application Priority Data
Jul. 12, 2023 (KR) 10-2023-0090577
Sep. 22, 2023 (KR) 10-2023-0127457

(51) Int. Cl. H02J 50/70; H02J 50/12; H02M 1/00; H02M 7/06

(52) U.S. Cl. CPC H02J 50/70; H02J 50/12; H02M 1/0003; H02M 7/062

(57) ABSTRACT

An electronic device for wireless charging may include a coil, a charging circuit, a rectifier circuit configured to rectify power that is wirelessly received from an external transmission device through the coil and output the rectified power to the charging circuit, a control circuit connected to the rectifier circuit and the charging circuit. The rectifier circuit may include diodes, a switch circuit including a plurality of switches connected to the diodes, and a comparison circuit connected to the coil and including at least one comparator configured to output an enable signal to the switch circuit based on a comparison of voltage values at both ends of the coil. The control circuit may control the rectifier circuit to output rectified power to the charging circuit using at least two switches among the plurality of switches based on the enable signal.

### CROSS-REFERENCE TO RELATED APPLICATIONS

This application is a continuation application of International Patent Application No. PCT/KR2024/009886 filed on Jul. 10, 2024, which claims priority to Korean Patent Application No. 10-2023-0090577, filed on Jul. 12, 2023, and Korean Patent Application No. 10-2023-0127457, filed on Sep. 22, 2023, in the Korean Intellectual Property Office, the disclosures of which are incorporated herein by reference in their entireties.

### BACKGROUND

The disclosure relates to an electronic device and method for wireless charging using magnetic resonance.

As wireless charging technology advances, research is being conducted on methods for supplying power to multiple electronic devices from a single charging device. This wireless charging technology utilizes wireless power transmission and reception, thereby allowing automatic battery charging simply by placing the electronic device on a charging pad, without connecting to a separate charging connector.

Electronic devices for wireless charging are being developed to be small and capable of low charging currents. Since small electronic devices for wireless charging use high frequencies, it is possible to miniaturize coils for wireless charging. Therefore, it may be advantageous for the wireless charging electronic device to utilize the magnetic resonance method when conducting wireless charging via wireless communication. Since wireless charging devices use low charging currents, they cannot operate in active rectification (sync) mode, so they typically use a diode-based rectifier. For rectifiers with output currents lower than 50 mA, the full sync mode, which offers high efficiency, cannot be used due to the change in rectification mode in the rectifier output current, and diode mode can be used.

### SUMMARY

One or more embodiments of the present disclosure provide an electronic device and method for wireless charging in order to improve the efficiency of a rectifier when using a magnetic resonance method for low-power charging.

In one or more embodiments of the present disclosure, an electronic device for wireless charging may include: a coil; a charging circuit; a rectifier circuit configured to rectify power that is wirelessly received from an external transmission device through the coil and output the rectified power to the charging circuit; a control circuit electrically connected to the rectifier circuit and the charging circuit. The rectifier circuit may include: a plurality of diodes; a switch circuit including a plurality of switches connected to the plurality of diodes; and a comparison circuit electrically connected to the coil and including at least one comparator configured to output an enable signal to the switch circuit based on a comparison of voltage values at both ends of the coil. The control circuit may be configured to control the rectifier circuit to output rectified power to the charging circuit using at least two switches among the plurality of switches based on the enable signal.

In one or more embodiments of the present disclosure, a rectifier included in an electronic device for wireless charging may include: a plurality of diodes; a switch circuit including a plurality of switches connected with the plurality of diodes; and a comparison circuit connected to a coil of the electronic device that receives wireless power from a transmission device and at least one comparator configured to output an enable signal to the switch circuit, based on a comparison of voltage values at both ends of the coil, wherein the switch circuit may be configured to turn on at least two switches among the plurality of switches, based on the enable signal, and output, to a charging circuit of the electronic device, power obtained by rectifying the wireless power using the two switches turned on.

In one or more embodiments of the present disclosure, an operation method in an electronic device for wireless charging, may include: receiving wireless power from a transmission device using a coil of the electronic device; outputting an enable signal to at least two switches among a plurality of switches included in a rectifier circuit of the electronic device, based on a comparison of voltage values at both ends of the coil, by a comparison circuit included in the rectifier circuit; and outputting power obtained by rectifying the wireless power to a charging circuit of the electronic device using the at least two switches, based on the enable signal, by the rectifier circuit of the electronic device.

According to an embodiment of the disclosure, an electronic device for wireless charging may include a coil, a charging circuit, a rectifier circuit configured to rectify wireless power received from a transmission device through the coil and output the rectified power to the charging circuit, and a control circuit electrically connected to the rectifier circuit and the power management circuit.

According to an embodiment, the rectifier circuit may include a plurality of diodes, a switch circuit including a plurality of switches connected in parallel with the plurality of diodes, and a comparison circuit electrically connected to both ends of the coil and including a plurality of comparators configured to output an enable signal to the switch circuit, based on a comparison of voltage values at both ends of the coil.

According to an embodiment, the control circuit may be configured to control the rectifier circuit to output rectified power to the charging circuit using at least two of the plurality of switches, based on the enable signal.

According to an embodiment, a rectifier, included in an electronic device, for wireless charging may include a plurality of diodes, a switch circuit including a plurality of switches connected in parallel with the plurality of diodes, and a comparison circuit connected to both ends of a coil of the electronic device that receives wireless power from a transmission device and including a plurality of comparators configured to output an enable signal to the switch circuit, based on a comparison of voltage values at both ends of the coil.

According to an embodiment, the switch circuit may be configured to turn on at least two switches among the plurality of switches, based on the enable signal, and output, to a charging circuit of the electronic device, power obtained by rectifying the wireless power using the two switches turned on.

According to an embodiment, an operation method in an electronic device for wireless charging may include receiving wireless power from a transmission device using a coil of the electronic device.

According to an embodiment, the method may include outputting an enable signal to two switches among a plurality of switches included in a rectifier circuit of the electronic device, based on a comparison of voltage values at both ends of the coil, by a comparison circuit included in the rectifier circuit.

According to an embodiment, the method may include outputting power obtained by rectifying the wireless power to a charging circuit of the electronic device using the two switches, based on the enable signal, by the rectifier circuit of the electronic device.

### BRIEF DESCRIPTION OF DRAWINGS

FIG. 1 is a block diagram of an electronic device in a network environment according to various embodiments.

FIGS. 2A and 2B are drawings illustrating an example of the configuration of an electronic device for wireless charging according to an embodiment.

FIGS. 3A, 3B, and 3C are drawings illustrating an example of the configuration of an external transmission device for wireless charging according to an embodiment.

FIG. 4A is a drawing illustrating an example of the configuration of a system for wireless charging according to an embodiment.

FIG. 4B is a drawing illustrating an example of the configuration of a rectifier circuit in an electronic device according to an embodiment.

FIGS. 5A, 5B, and 5C are drawings illustrating an example of the configuration of a rectifier circuit in an electronic device according to an embodiment.

FIG. 6 is a drawing illustrating the operation timing of a rectifier circuit in an electronic device according to an embodiment.

FIG. 7 is a drawing illustrating an example of the configuration of a rectifier circuit in an electronic device according to an embodiment.

FIGS. 8A and 8B are drawings illustrating an example of the configuration of a rectifier circuit in an electronic device according to an embodiment.

FIG. 9 is a drawing illustrating the operation timing of a rectifier circuit in an electronic device according to an embodiment.

FIGS. 10A and 10B are drawings illustrating an example of the configuration of a rectifier circuit in an electronic device according to an embodiment.

FIG. 11 is a drawing illustrating the operation timing of a rectifier circuit in an electronic device according to an embodiment.

FIG. 12 is a drawing illustrating an example of an operation method in an electronic device according to an embodiment.

FIG. 13 is a drawing illustrating an example of an operation method in an electronic device according to an embodiment.

In the description of the drawings, the same or similar reference numerals may be used for the same or similar components.

### DETAILED DESCRIPTION

Hereinafter, embodiments of the disclosure will be described in detail with reference to the drawings so that those skilled in the art to which the disclosure pertains are capable of easily implementing the disclosure. However, the disclosure may be implemented in various different forms and is not limited to the embodiments described herein. In connection with the description of the drawings, the same or similar reference numerals may be used to indicate the same or similar components. Furthermore, in the drawings and related descriptions, descriptions of well-known functions and configurations may be omitted for clarity and conciseness. The term “user” used in the embodiments of the disclosure may refer to a person using an electronic device or a device (e.g., an artificial intelligence electronic device) using the electronic device.

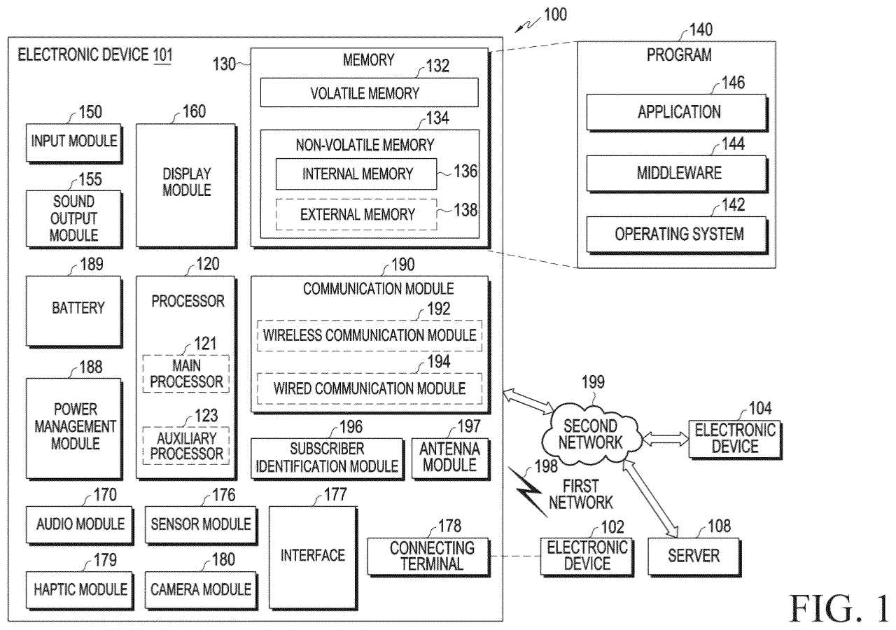

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In related art, an electronic device may apply a rectified voltage from AC power, processed through diodes, to a charging circuit. In this configuration, a voltage drop may occur, meaning that the peak voltages of AC1 and AC2 received from the coil are not used as the maximum voltages. The rectified voltage (V_RECT) may be reduced due to the forward voltage (V_F) of the diodes. A typical diode has a V_F of approximately 0.7 V, while a Schottky diode, which has a lower V_F (e.g., 0.27 V), reduces the voltage even more. When the rectifier converts AC to DC, the current passes through diodes, causing a voltage drop of around 0.54 V. This voltage drop may lead to a decrease in the efficiency of the wireless charging device. The electronic device in one or more embodiments of the present disclosure may address these issues.

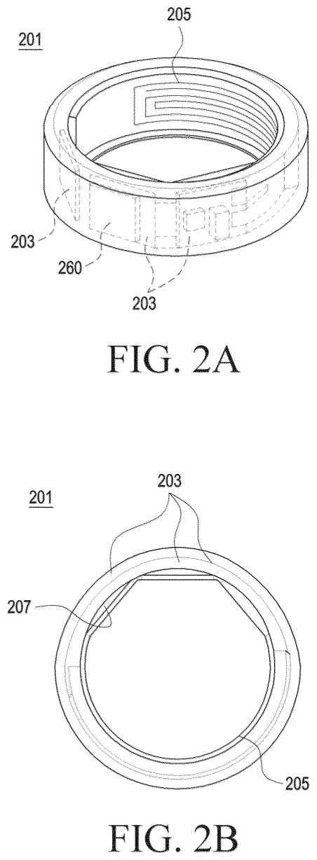

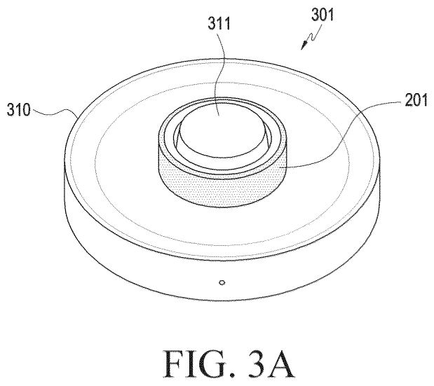

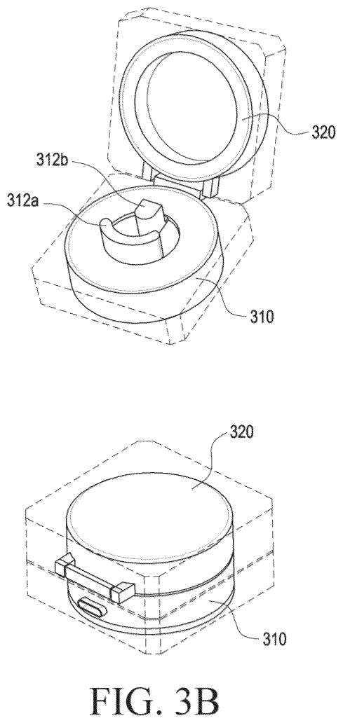

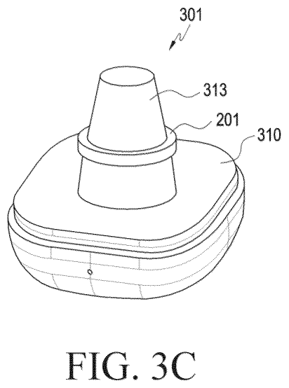

FIGS. 2A and 2B are drawings illustrating an example of the configuration of an electronic device for wireless charging according to an embodiment, and FIGS. 3A, 3B, and 3C are drawings illustrating an example of the configuration of an external transmission device for wireless charging according to an embodiment.

Referring to FIGS. 2A, 2B, 3A, and 3B, an electronic device 201 (e.g., the electronic device 101 in FIG. 1) according to an embodiment may be a reception device (e.g., an RX device) for wireless charging, and may perform wireless charging using wireless power provided from a transmission device (e.g., a TX device) 301 using a magnetic resonance method via a short-range wireless communication method (e.g., near-field communication (NFC) communication). According to an embodiment, the electronic device 201 may be a small wireless charging device that performs low-power wireless charging using a low charging current. As illustrated in FIGS. 2A and 2B, an electronic device 201 according to an embodiment may be a wearable device in the form of a ring (e.g., a smart ring). The outer surface of the electronic device 201 according to an embodiment may be formed in a circular shape, and at least one inner surface of the electronic device 201 may be formed flat. The electronic device 201 according to an embodiment may be worn on a part (e.g., a finger) of a user's body.

The electronic device 201 according to an embodiment may include a printed circuit board (PCB) 203 and a conductive pattern 205. The electronic device 201 according to an embodiment may include at least one printed circuit board 203 therein. The printed circuit board 203 according to an embodiment may include at least one control circuit 260 and at least one sensor 207. For example, the sensor 207 may include at least one of a photo diode (PD), a light-emitting diode (LED), or a temperature sensor, but is not limited thereto. Some (e.g., the sensor 207) of the above components may be omitted.

According to an embodiment, the control circuit 260 included in the printed circuit board 203 may detect the body temperature, heart rate, or electrocardiogram (ECG) of the user using at least one sensor 207, but is not limited thereto.

According to an embodiment, the conductive pattern 205 may include a ring-shaped coil. The conductive pattern 205 according to an embodiment may include a conductive material (e.g., copper (Cu)). The conductive pattern 205 according to an embodiment may include a coil formed of a conductive material. The control circuit 260 according to an embodiment may transmit or receive a signal using the conductive pattern 205. For example, the control circuit 260 may receive power wirelessly through the conductive pattern 205.

This configuration is merely an example and the disclosure is not limited thereto, and the electronic device 201 may be configured in various other forms. According to an embodiment, the electronic device 201 may include circuits (e.g., elements, modules, or components) for performing wireless charging within a housing.

As illustrated in FIGS. 3A and 3B, the electronic device 201 according to an embodiment may be positioned in a portion of a first housing 310, which is the lower housing of an external transmission device 301 that supplies wireless power. The first housing 310, in which the electronic device 201 is positioned, may have a protrusion 311 (e.g., a circular or cylindrical member or a support member) in its central area, and at least one antenna may be positioned on one surface of the protrusion 311. The electronic device 201 according to an embodiment may be positioned in the protrusion 311 of the external transmission device 301. According to an embodiment, the electronic device 201 may be positioned such that at least a portion of the protrusion 311 of the external transmission device 301 is inserted thereinto. The electronic device 201 according to an embodiment may be positioned parallel to the first housing 310 of the external transmission device 301. According to an embodiment, the electronic device 201 may be mounted at a height of the protrusion 311 that corresponds to the size of the electronic device 201. For example, the external transmission device 301 may include a first housing 310 as a lower housing and a second housing 320, facing (opposing) the first housing 310, as an upper housing configured to be openable and closable. For example, the first housing 310 and the second housing 320 may be formed in a shape (e.g., a cradle) illustrated in solid lines or may be formed to be included in a case illustrated in dotted lines. The first housing 310 and the second housing 320 are not limited to the shapes illustrated in FIGS. 3A to 3C and may be configured in various other shapes.

According to an embodiment, the external transmission device 301 is not limited to the above-described configurations and may further include other components necessary for wireless charging. According to an embodiment, the protrusion 311 of the external transmission device 301 is not limited to the shape illustrated in FIG. 3A, and it may be configured to have a plurality of protruding members 312a and 312b (e.g., support members) in the central area, as illustrated in FIG. 3B, or may be configured as a conical protrusion 313, as illustrated in FIG. 3C. In addition, it may be implemented in various other shapes.

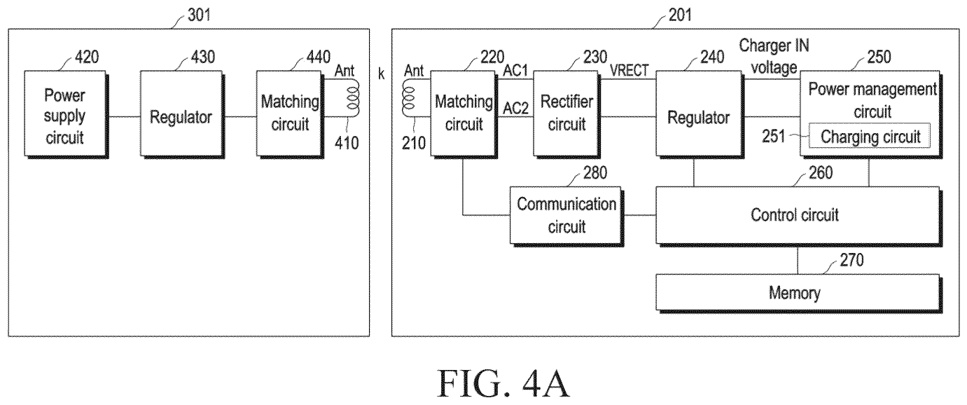

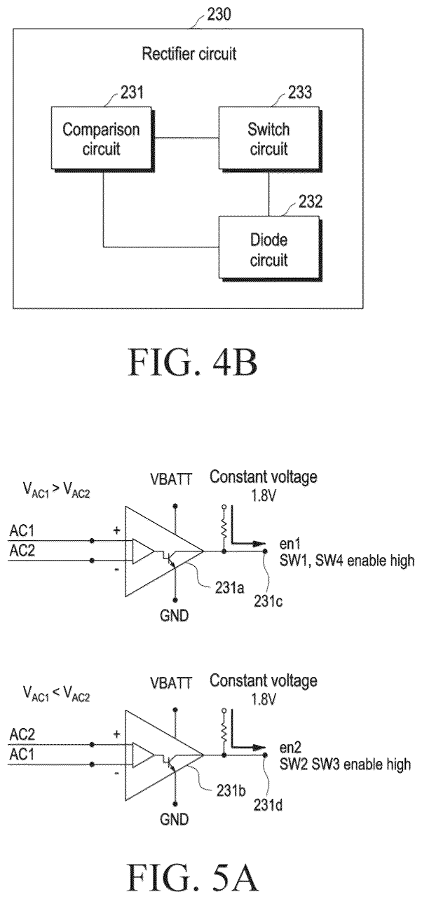

FIG. 4A is a drawing illustrating an example of the configuration of a system for wireless charging according to an embodiment.

Referring to FIG. 4A, according to an embodiment, an electronic device 201 may be connected to an external transmission device 301 that transmits wireless power via short-range wireless communication. The transmission device 301 may include circuits (e.g., elements, modules, or components) for transmitting wireless power for wireless charging to the electronic device 201, which is a reception device. For example, the transmission device 301 may include a power supply circuit 420, a regulator 430, a matching circuit 440 for matching antennas, and a coil 410. For example, the transmission device 301 may include a control circuit for controlling the power supply circuit 420, the regulator 430, the matching circuit 440, and the coil 410, and a communication circuit. The regulator 430 may include components (e.g., a converter and/or amplifier) for converting the voltage received from the power supply circuit 420 to a specific voltage. The matching circuit 440 may match the impedance between the regulator 430 and the coil 410 to increase power transmission efficiency. The coil 410 may transmit wireless power using a resonant frequency specified according to the voltage applied from the matching circuit 440.

According to an embodiment, the electronic device 201 may include a power reception circuit including a coil 210, a matching circuit 220, a rectifier circuit 230, a regulator 240, a power management circuit (PMIC) 250 including a charging circuit 251, a control circuit 260, a memory 270 and/or a communication circuit 280,. In addition, the electronic device 201 may further include other components necessary for wireless charging.

According to an embodiment, the electronic device 201 may receive wireless power (e.g., AC power) from a transmission device 301 using a designated resonant frequency through the coil 210 (e.g., a resonator) included in the power reception circuit. The electronic device 201 may further include other components necessary for receiving wireless power.

According to an embodiment, the matching circuit 220 of the electronic device 201 may be configured to perform impedance matching to match at least one short-range wireless communication antenna (e.g., an NFC antenna) to increase the efficiency of wireless power reception. The matching circuit 220 may be configured to apply AC1 voltage and AC2 voltage applied to both ends of the coil 210 to the rectifier circuit 230. For example, the matching circuit 220 may be configured to be electrically connected to the coil 210, the communication circuit 280, and the control circuit 260.

According to an embodiment, the rectifier circuit 230 of the electronic device 201 may be configured to rectify the AC voltage applied from the coil 211 into a DC voltage and output the rectified DC voltage to the regulator 240. The rectifier circuit 230 may be configured to be electrically connected to the matching circuit 220 and the regulator 240.

According to an embodiment, the regulator 240 of the electronic device 201 may be configured to convert the voltage VRECT rectified by the rectifier circuit 230 into a specific DC voltage and process signals transmitted/received through communication with the transmission device 301. The regulator 240 may be configured to be electrically connected to the rectifier circuit 230, the power management circuit 250, and the control circuit 260.

According to an embodiment, the power management circuit 250 of the electronic device 201 may include a charging circuit (e.g., a battery) 251 and components for managing wireless charging, and may be configured to perform charging by applying the voltage (e.g., a specific DC voltage (VBUS_SV)) output from the regulator 240 to the charging circuit 251. The power management circuit 250 may be configured to be electrically connected to the regulator 240 and the control circuit 260. The voltage that is output from the regulator 240 and is input to the charging circuit 251 may be referred to as a charging voltage. In some embodiments, one or more additional circuit components may be placed between the regulator 240 and the charging circuit 251, in which case the charging voltage may refer to the voltage supplied to the charging circuit 251, either directly or indirectly from the regulator 240.

According to an embodiment, the control circuit 260 of the electronic device 201 may control overall operations for wireless charging, and may control the operation of the electrically connected rectifier circuit 230, regulator 240, and power management circuit 250. The control circuit 260 may obtain state information and/or control information related to wireless charging, and control the communication circuit 280 to store the state information and/or control information related to wireless charging in the memory 270 or transmit it to an external electronic device (e.g., the transmission device 301).

According to an embodiment, the communication circuit 280 of the electronic device 201 may include at least one short-range wireless communication antenna (e.g., an NFC antenna or a BLE antenna) for wireless charging. For example, the communication circuit 280 may transmit state information and/or control information related to wireless charging to the external transmission device 301 using a wireless communication scheme (e.g., a BLE (Bluetooth low energy) scheme).

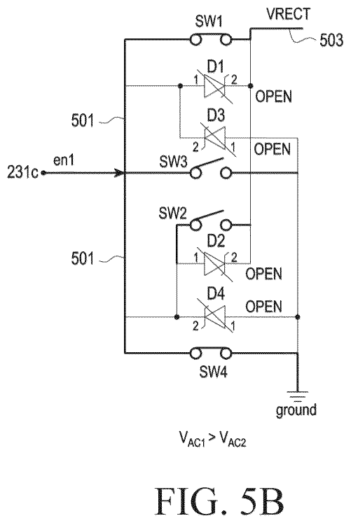

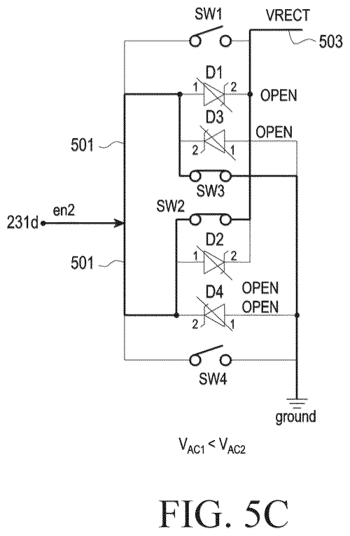

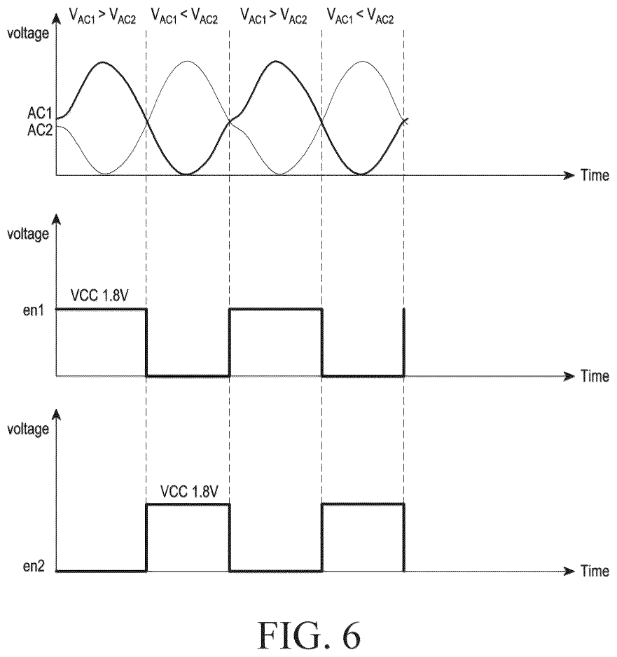

FIG. 4B is a drawing illustrating an example of the configuration of a rectifier circuit in an electronic device according to an embodiment, FIGS. 5A, 5B, and 5C are drawings illustrating an example of the configuration of a rectifier circuit in an electronic device according to an embodiment, and FIG. 6 is a drawing illustrating the operation timing of a rectifier circuit in an electronic device according to an embodiment.

Referring to FIGS. 4B, 5A, 5B, 5C, and 6, the rectifier circuit 230 of the electronic device 201 according to an embodiment may include a comparison circuit 231, a diode circuit 232 including a plurality of diodes D1, D2, D3, and D4, and a switch circuit 233. The rectifier circuit 230 may rectify (e.g., convert) wireless power (e.g., AC power) received from the coil 210 (into DC power), and apply the rectified power to the charging circuit 251 (e.g., a battery) through the regulator 240.

According to an embodiment, the comparison circuit 231 may be electrically connected to the coil 210, and electrically connected to the diode circuit 232 including a plurality of diodes D1, D2, D3, and D4 and the switch circuit 233. According to an embodiment, the comparison circuit 231, under the control of the control circuit 260, may be configured to output an enable signal (e.g., a first enable signal en1 or a second enable signal en2) to the switch circuit 233, based on a comparison of voltage values (e.g., a first voltage value VAC1 or a second voltage value VAC2) at both ends of the coil 210. According to an embodiment, the comparison circuit 231 may include a single comparator (e.g., either a first comparator 231a or a second comparator 231b) or a plurality of comparators (e.g., the first comparator 231a and the second comparator 231b). The comparison circuit 231 may constantly apply a voltage (e.g., VCC 1.8 V) to the plurality of diodes and the switch circuit 233 according to the enable signal (e.g., the first enable signal en1 or the second enable signal en2).

According to an embodiment, among the plurality of comparators, a first comparator 231a may have a + terminal electrically connected to one end (e.g., AC1 output terminal) of the coil 210 and a − terminal electrically connected to the other end (e.g., AC2 output terminal) of the coil 210. The first comparator 231a, under the control of the control circuit 260, may output a first enable signal en1 to the switch circuit 233 when a first voltage value VAC1 applied to the + terminal is greater than a second voltage value VAC2 applied to the − terminal.

According to an embodiment, among the plurality of comparators, a second comparator 231b may have a − terminal electrically connected to one end (e.g., AC1 output terminal) of the coil 210 and a + terminal electrically connected to the other end (e.g., AC2 output terminal) of the coil 210 under the control of the control circuit 260. The second comparator 231b may output a second enable signal en2 to the switch circuit 233 when the second voltage value VAC2 applied to the + terminal is greater than the first voltage value VAC1 applied to the − terminal.

According to an embodiment, the switch circuit 233 may include a plurality of switches SW1, SW2, SW3, and SW4. The switch circuit 233 may be configured such that an input terminal 501 is electrically connected to an output terminal 231c and/or 231d of the comparison circuit 231 and an output terminal 503 is electrically connected to the regulator 240. In addition, the switch circuit 233 may apply the rectified voltage VRECT to the regulator 240 connected to the charging circuit (e.g., battery) 251, based on the first enable signal en1 or the second enable signal en2 output from the comparison circuit 231. The plurality of switches SW1, SW2, SW3, and SW4 may be connected in parallel with the plurality of diodes D1, D2, D3, and D4, respectively.

According to an embodiment, the switch circuit 233 may be configured such that, based on the reception of the first enable signal en1, the first switch SW1 and the fourth switch SW4 among the plurality of switches are turned on, and the second switch SW2 and the third switch SW3 are turned off. The first switch SW1 may be connected in parallel with the first diode D1, and may be configured such that one end is connected to the comparison circuit 231, and the other end is connected to an output terminal connected to the regulator 240. The fourth switch SW4 may be connected in parallel with the fourth diode D4, and may be configured such that one end is connected to the comparison circuit 231, and the other end is connected to ground.

According to an embodiment, the switch circuit 233 may be configured such that, based on the reception of the second enable signal en2, the second switch SW2 and the third switch SW3 are turned on, and the first switch SW1 and the fourth switch SW4 are turned off. The second switch SW2 may be connected in parallel with the second diode D2, and may be configured such that one end is connected to the comparison circuit 231, and the other end is connected to an output terminal connected to the regulator 240. The third switch SW3 may be connected in parallel with the third diode D3, and may be configured such that one end is connected to the comparison circuit 231, and the other end is connected to ground. According to an embodiment, the rectifier circuit 230 may operate according to the timing configuration of the enable signal, as illustrated in FIG. 6. According to an embodiment, as illustrated in FIG. 6, the first enable signal en1 may be output as the output terminal (e.g., enable terminal) of the first comparator 231a of the comparison circuit 231 is turned on (e.g., high) when the first voltage value VAC1 at one end (e.g., the first terminal) of the coil is greater than the second voltage value VAC2. According to an embodiment, as illustrated in FIG. 6, the second enable signal en2 may be output as the output terminal (e.g., enable terminal) of the second comparator 231b of the comparison circuit 231 is turned on (e.g., high) when the second voltage value VAC2 at the other end (e.g., second terminal) of the coil is greater than the first voltage value VAC1.

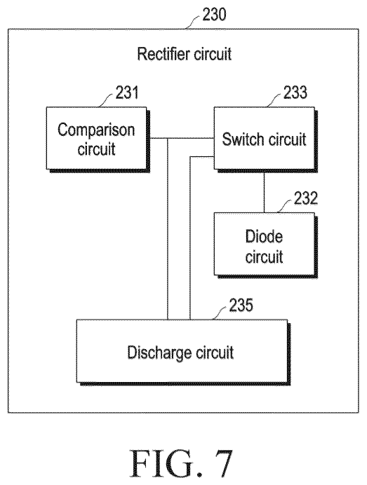

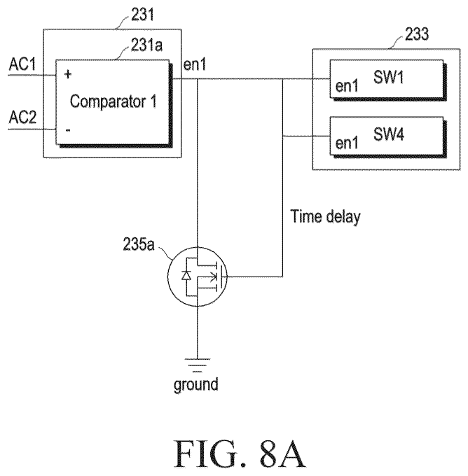

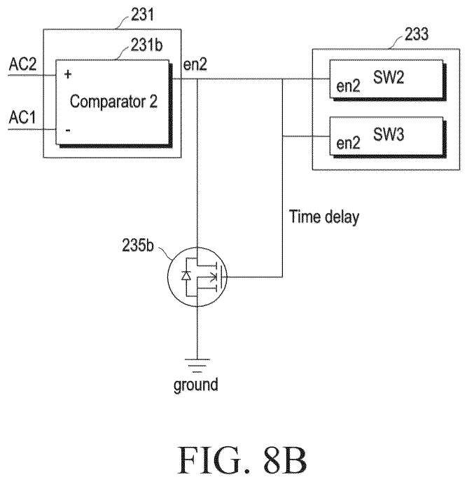

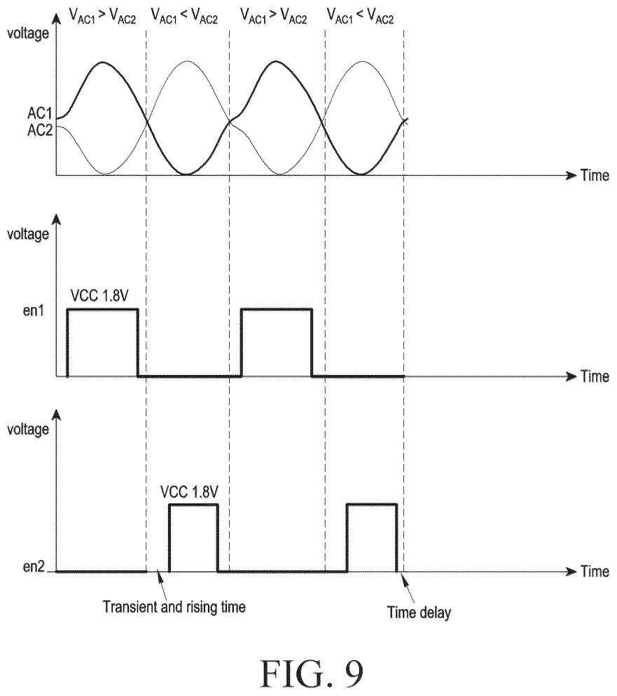

FIG. 7 is a drawing illustrating an example of the configuration of a rectifier circuit in an electronic device according to an embodiment, FIGS. 8A and 8B are drawings illustrating an example of the configuration of a rectifier circuit in an electronic device according to an embodiment, and FIG. 9 is a drawing illustrating the operation timing of a rectifier circuit in an electronic device according to an embodiment.

Referring to FIGS. 7, 8A, 8B, and 9, the rectifier circuit 230 of the electronic device 201 according to an embodiment may include a comparison circuit 231, a plurality of diodes 232, and a switch circuit 233, and may further include a discharge circuit 235 to ensure stability. The comparison circuit 231, the plurality of diodes 232, and the switch circuit 233 are substantially the same as those in the embodiment shown in FIG. 4B above, and a detailed description of the comparison circuit 231, the plurality of diodes 232, and the switch circuit 233 will be omitted from the description in FIG. 7.

The discharge circuit 235 of the electronic device 201 according to an embodiment may be configured to be electrically connected to the comparison circuit 231 and the switch circuit 233. The discharge circuit 235 may include a plurality of transistors 235a and 235b electrically connected to output terminals (e.g., enable terminals) of a plurality of comparators 231a and 231b and at least two switches (e.g., SW1 and SW4, or SW2 and SW3). The discharge circuit 235 may be electrically connected to a control circuit 260 and may perform a time delay operation for outputting an enable signal under the control of the control circuit 260.

The discharge circuit 235 of the electronic device 201 according to an embodiment may be configured to output an enable signal of the comparison circuit 231 with a specified time delay according to a timing configured to compensate for the transient time (e.g., rising time) of the plurality of switches included in the switch circuit 233.

Referring to FIG. 8A, the first transistor 235a of the discharge circuit 235 according to an embodiment may be electrically connected to the output terminal (e.g., enable terminal) of the first comparator 231a, the input terminal of the first switch SW1, and the input terminal of the fourth switch SW4. When the output terminal of the first comparator 231a is switched to an enabled state (e.g., an active state) and the voltage rises to a high level (e.g., VCC 1.8 V), the first transistor 235a of the discharge circuit 235 may forcibly disable the output terminal of the first comparator 231a by turning on (high) the gate of the first transistor 235a so as to delay the output of the first enable signal en1 for a specified period of time. The electronic device 201 may prevent reverse leakage current from being generated due to the transient time after the first switch SW1 and the fourth switch SW4 are turned on according to the enable signal. The turn-on time of the first switch SW1 and the fourth switch SW4 may be configured as a time specified by the time delay.

Referring to FIG. 8B, the first transistor 235b of the discharge circuit 235 according to an embodiment may be electrically connected to the output terminal (e.g., enable terminal) of the second comparator 231b, the input terminal of the second switch SW2, and the input terminal of the third switch SW3. When the output terminal of the second comparator 231b is switched to an enabled state (e.g., an active state) and the voltage rises to a high level (e.g., VCC 1.8 V), the second transistor 235b of the discharge circuit 235 may forcibly disable the output terminal of the second comparator 231b by turning on (high) the gate of the second transistor 235b so as to delay the output of the second enable signal en2 for a specified period of time. The electronic device 201 may prevent reverse leakage current from being generated due to the transient time after the second switch SW2 and the third switch SW3 are turned on according to the enable signal. The turn-on time of the second switch SW2 and the third switch SW3 may be configured as a time specified by the time delay.

According to an embodiment, the rectifier circuit 230 may operate according to the timing configuration of the enable signal according to the time delay by the discharge circuit 235, as illustrated in FIG. 9. According to an embodiment, as illustrated in FIG. 9, when the first voltage value VAC1 at one end (e.g., the first terminal) of the coil is greater than the second voltage value VAC2, the output terminal (e.g., enable terminal) of the first comparator 231a of the comparison circuit 231 may be forcibly disabled by the discharge circuit 235, so that the first enable signal en1 may be output after a specified time delay. According to an embodiment, as illustrated in FIG. 9, when the second voltage value VAC2 at the other end (e.g., the second terminal) of the coil is greater than the first voltage value VAC1, the output terminal (e.g., enable terminal) of the second comparator 231b of the comparison circuit 231 may be forcibly disabled by the discharge circuit 235, so that the second enable signal en2 may be output after a specified time delay.

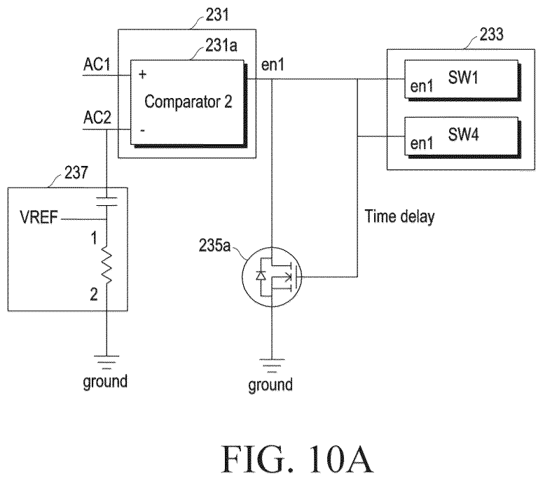

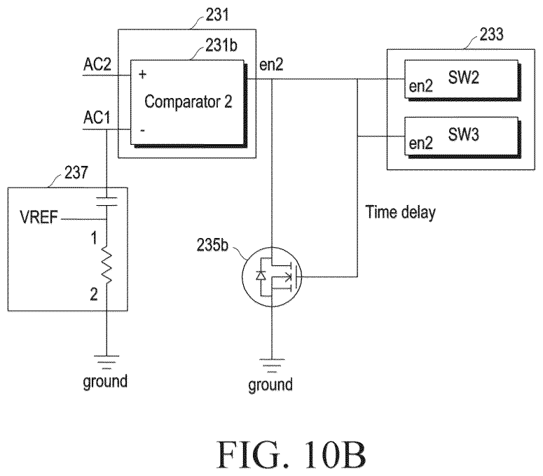

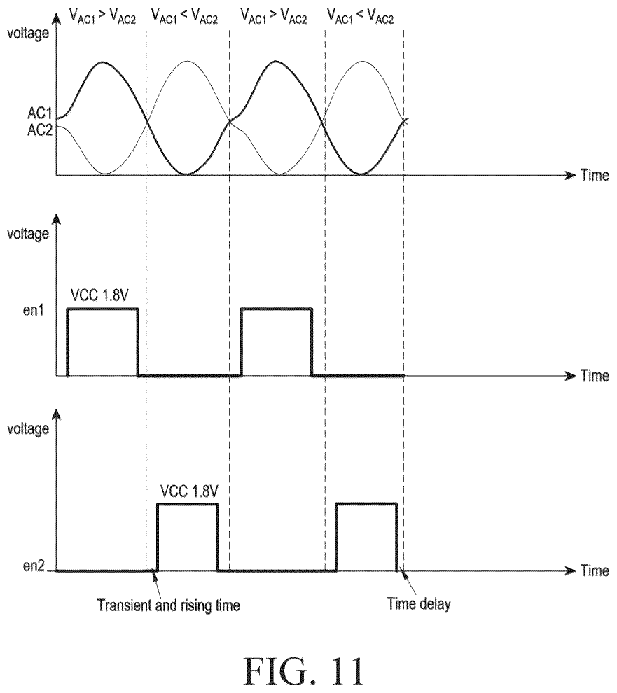

FIGS. 10A and 10B are drawings illustrating an example of the configuration of a rectifier circuit in an electronic device according to an embodiment, and FIG. 11 is a drawing illustrating the operation timing of a rectifier circuit in an electronic device according to an embodiment.

Referring to FIGS. 10A, 10B, and 11, the rectifier circuit 230 of the electronic device 201 according to an embodiment may include a comparison circuit 231, a switch circuit 233, and a discharge circuit 235, and may further include a voltage control circuit 237 to ensure stability and compensate for the transient time after a plurality of switches are turned on. The comparison circuit 231 and the switch circuit 233 are substantially the same as those of the embodiment in FIG. 4B or FIG. 7 described above, and for convenience of explanation, the diode circuit 232 including the plurality of diodes D1, D2, D3, and D4 have been omitted from FIGS. 10A and 10B, but the rectifier circuit 230 may include a diode circuit 232 substantially the same as that in FIG. 7. The discharge circuit 235 is substantially the same as the discharge circuit 235 in FIG. 7, and detailed descriptions of the comparison circuit 231, the plurality of diodes 232, and the switch circuit 233 will be omitted from the descriptions relate to FIGS. 10A and 10B.

The voltage control circuit 237 of the electronic device 201 according to an embodiment may include components (e.g., a capacitor and a resistor) that are electrically connected to each of the plurality of comparators 231a and 231b and apply a reference voltage to each of the plurality of comparators 231a and 231b. For example, the discharge circuit 235 may include a plurality of transistors 235a and 235b that are electrically connected to the output terminals (e.g., enable terminals) of the plurality of comparators 231a and 231b and at least two switches (e.g., SW1 and SW4, or SW2 and SW3). For example, the voltage control circuit 237 may be configured such that a single circuit is connected to the plurality of comparators 231a and 231b, or may be configured as a plurality of circuits connected to the plurality of comparators 231a and 231b, respectively.

The voltage control circuit 237 of the electronic device 201 according to an embodiment may be configured to compensate for the transient time (e.g., rising time) after the plurality of switches of the switch circuit 233 are turned on, based on a reference voltage VREF value. For example, when the control circuit 260 performs control to increase the reference voltage value of the voltage control circuit 237, the reference value for voltage comparison of the plurality of comparators 231a and 231b may increase, and thus the plurality of comparators 231a and 231b may perform a time delay operation for outputting a first enable signal en1 of the first comparator 231a and a second enable signal en2 of the second comparator 231b. When the control circuit 260 performs control to decrease the reference voltage value of the voltage control circuit 237, the timing time configured for enable outputs of the plurality of comparators 231a and 231b may be advanced, as illustrated in FIG. 11. The rectifier circuit 230 may secure stability and improve operating efficiency by adjusting the reference value of the voltage control circuit 237.

Referring to FIG. 10A, the first transistor 235a of the discharge circuit 235 according to an embodiment may be electrically connected to the output terminal (e.g., enable terminal) of the first comparator 231a, the input terminal of the first switch SW1, and the input terminal of the fourth switch SW4. The voltage control circuit 237 may be connected to the − input terminal of the first comparator 231a and ground, and may apply a reference voltage to compensate for the timing of the first enable signal en1 to the first comparator 231a. When the voltage of the output terminal of the first comparator 231a rises to a high level (e.g., VCC 1.8 V), the first transistor 235a of the discharge circuit 235 may forcibly disable the output terminal of the first comparator 231a by turning on (high) the gate of the first transistor 235a so as to delay the output of the first enable signal en1 for a specified period of time. The electronic device 201 may prevent reverse leakage current from being generated due to the transient time after the first switch SW1 and the fourth switch SW4 are turned on according to the enable signal. The turn-on time of the first switch SW1 and the fourth switch SW4 may be configured as a time specified by the time delay.

Referring to FIG. 10B, the second transistor 235b of the discharge circuit 235 according to an embodiment may be electrically connected to the output terminal (e.g., enable terminal) of the second comparator 231b, the input terminal of the second switch SW2, and the input terminal of the third switch SW3. The voltage control circuit 237 may be connected to the − input terminal of the second comparator 231b and ground, and may apply a reference voltage to compensate for the timing of the second enable signal en2 to the second comparator 231b. When the voltage of the output terminal of the second comparator 231b rises to a high level (e.g., VCC 1.8 V), the second transistor 235b of the discharge circuit 235 may forcibly disable the output terminal of the second comparator 231b by turning on (high) the gate of the second transistor 235b so as to delay the output of the second enable signal en2 for a specified period of time. The electronic device 201 may prevent reverse leakage current from being generated due to the transient time after the second switch SW2 and the third switch SW3 that are turned on according to the enable signal. The turn-on time of the second switch SW2 and the third switch SW3 may be configured as a time specified by the time delay.

According to an embodiment, the rectifier circuit 230 may operate according to the timing configuration of the enable signal according to the time delay by the discharge circuit 235, as illustrated in FIG. 11. According to an embodiment, as illustrated in FIG. 11, when the first voltage value VAC1 at one end (e.g., the first end) of the coil is greater than the second voltage value VAC2, the output terminal (e.g., enable terminal) of the first comparator 231a of the comparison circuit 231 may be forcibly disabled by the discharge circuit 235, so that the first enable signal en1 may be output after a specified time delay. According to an embodiment, as illustrated in FIG. 11, when the second voltage value VAC2 of the other terminal (e.g., the second terminal) of the coil is greater than the first voltage value VAC1, the output terminal (e.g., en terminal) of the second comparator 231b of the comparison circuit 231 may be forcibly disabled by the discharge circuit 235, so that the second enable signal en2 may be output after a specified time delay.

As described above, the primary components of the electronic device have been described through the electronic device 201 in FIGS. 2A, 2B, 3A, and 3B in an embodiment. However, in various embodiments, not all of the components illustrated in FIGS. 2A, 2B, 3A, and 3B are essential components, and the electronic device 201 may be implemented with more or fewer components than the illustrated components. Furthermore, the locations of the primary components of the electronic device 201 described above in FIGS. 2A, 2B, 3A, and 3B may vary depending on various embodiments.

According to an embodiment, an electronic device (e.g., the electronic device 201 in FIGS. 2A, 2B, 3A, and 4A) for wireless charging may include a coil (e.g., the coil 210 in FIG. 4A), a charging circuit (e.g., the charging circuit 251 in FIG. 4A), a rectifier circuit (e.g., the rectifier circuit 230 in FIGS. 4A, 4B, and 7) configured to rectify wireless power received from a transmission device (the transmission device 301 in FIG. 4A) through the coil and output the rectified power to the charging circuit, and a control circuit (e.g., the control circuit 260 in FIG. 4A) electrically connected to the rectifier circuit and the power management circuit.

According to an embodiment, the rectifier circuit may include a plurality of diodes (e.g., the plurality of diodes D1, D2, D3, and D4 in FIGS. 5B and 5C), a switch circuit (e.g., the switch circuit 233 in FIGS. 4B, 7, 8A, 8B, 10A, and 10B) including a plurality of switches (e.g., the plurality of switches SW1, SW2, SW3, and SW4 in FIGS. 5B and 5C) connected in parallel with the plurality of diodes, and a comparison circuit (e.g., the comparison circuit 231 in FIGS. 4B, 7, 8A, 8B, 10A, and 10B) electrically connected to both ends of the coil and including a plurality of comparators configured to output an enable signal to the switch circuit, based on a comparison of voltage values at both ends of the coil.

According to an embodiment, the control circuit may be configured to control the rectifier circuit to output rectified power to the charging circuit using at least two of the plurality of switches, based on the enable signal.

According to an embodiment, the rectifier circuit may be configured to output a first enable signal from a first comparator (e.g., the first comparator 231a in FIGS. 5A, 8A, and 10A) among the plurality of comparators, based on a first voltage value at one end of the coil exceeding a second voltage value at the other end of the coil.

According to an embodiment, the rectifier circuit may be configured, based on the first enable signal, to turn on a first switch and a fourth switch among the plurality of switches and turn off a second switch and a third switch among the plurality of switches, and apply an output voltage to the charging circuit through the first switch and the fourth switch. The first switch may be connected to the charging circuit, and the fourth switch may be connected to ground.

According to an embodiment, the rectifier circuit may be configured to output a second enable signal from a second comparator (e.g., the second comparator 231b in FIGS. 5A, 8B, and 10B) among the plurality of comparators, based on a second voltage value at the other end of the coil exceeding a first voltage value at one end of the coil,

According to an embodiment, the rectifier circuit may be configured, based on the second enable signal, to turn on a second switch and a third switch among the plurality of switches and turn off a first switch and a fourth switch among the plurality of switches, and apply an output voltage to the charging circuit through the second switch and the third switch. The second switch may be electrically connected to the charging circuit, and the third switch may be electrically connected to ground.

According to an embodiment, the rectifier circuit may further include a discharge circuit 235 configured to output the enable signal after delaying the enable signal by a specified time. According to an embodiment, the discharge circuit may include a plurality of transistors. According to an embodiment, a first transistor among the plurality of transistors may be electrically connected to an enable pin of a first comparator among the plurality of comparators and a first switch and a fourth switch among the plurality of switches. According to an embodiment, a second transistor among the plurality of transistors may be electrically connected to an enable pin of a second comparator among the plurality of comparators and a second switch and a third switch among the plurality of switches.

According to an embodiment, the rectifier circuit may further include a voltage control circuit, and the voltage control circuit may be electrically connected to each of the plurality of comparators and may be configured to compensate for a transient time after the plurality of switches are turned on, based on a reference voltage value.

According to an embodiment, the rectifier circuit may use a magnetic resonance method for low-power wireless charging, and each of the plurality of switches may be a transistor.

According to an embodiment, a rectifier 230, included in an electronic device 201, for wireless charging, may include a plurality of diodes 235, a switch circuit 233 including a plurality of switches connected in parallel with the plurality of diodes, and a comparison circuit 231 connected to both ends of a coil 210 of the electronic device that receives wireless power from a transmission device 301 and including a plurality of comparators configured to output an enable signal to the switch circuit, based on a comparison of voltage values at both ends of the coil.

According to an embodiment, the switch circuit may be configured to turn on at least two switches among the plurality of switches, based on the enable signal, and output, to a charging circuit (e.g., the charging circuit 251 in FIG. 3B) of the electronic device, power obtained by rectifying the wireless power using the two switches turned on.

According to an embodiment, the comparison circuit may be configured to output a first enable signal from a first comparator among the plurality of comparators, based on a first voltage value at one end of the coil exceeding a second voltage value at the other end of the coil.

According to an embodiment, the switch circuit may be configured, based on the first enable signal, to turn on a first switch and a fourth switch among the plurality of switches and turn off a second switch and a third switch among the plurality of switches, thereby applying an output voltage to the charging circuit through the first switch and the fourth switch.

According to an embodiment, the comparison circuit may be configured to output a second enable signal from a second comparator among the plurality of comparators, based on a second voltage value at the other end of the coil exceeding a first voltage value at one end of the coil.

According to an embodiment, the switch circuit may be configured, based on the second enable signal, to turn on a second switch and a third switch among the plurality of switches and turn off a first switch and a fourth switch among the plurality of switches, thereby applying an output voltage to the charging circuit through the second switch and the third switch.

According to an embodiment, the rectifier may further include a discharge circuit (e.g., the discharge circuit 235 in FIG. 7) configured to output the enable signal after delaying the enable signal by a specified time.

According to an embodiment, the discharge circuit may include a plurality of transistors, and a first transistor among the plurality of transistors may be electrically connected to an enable pin of a first comparator among the plurality of comparators and a first switch and a fourth switch among the plurality of switches, and a second transistor among the plurality of transistors may be electrically connected to an enable pin of a second comparator among the plurality of comparators and a second switch and a third switch among the plurality of switches.

According to an embodiment, the rectifier may further include a voltage control circuit (e.g., the voltage control circuit 237 in FIGS. 10A and 10B), and the voltage control circuit may be electrically connected to each of the plurality of comparators and may be configured to compensate for a transient time after the plurality of switches are turned on, based on a reference voltage value.

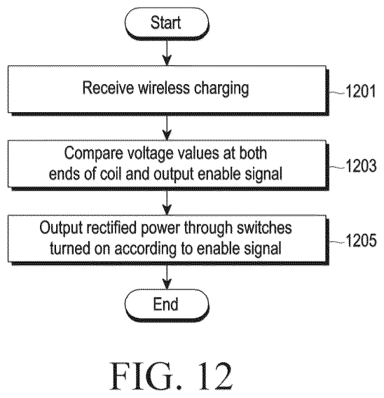

FIG. 12 is a drawing illustrating an example of an operation method in an electronic device according to an embodiment. In the following embodiments, the operations may be performed sequentially, but are not necessarily performed sequentially. For example, the sequence of the operations may be changed, and at least two operations may be performed in parallel.

Referring to FIG. 12, in operation 1201, an electronic device (e.g., the electronic device 101 in FIG. 1 and the electronic device 201 in FIGS. 2A, 2B, 3A, and 3B) according to an embodiment may connect to a transmission device (e.g., the external transmission device 301 in FIGS. 3A and 3B) using a short-range wireless communication scheme (e.g., NFC communication) for wireless charging. The electronic device may receive wireless power from the transmission device using the short-range wireless communication scheme via a coil (e.g., the coil 210 in FIG. 3B).

In operation 1203, the electronic device according to an embodiment may obtain voltage values at both ends of the coil, and output an enable signal to a switch circuit (e.g., the switch circuit 233 in FIGS. 4B, 7, 8A, 8B, 10A, and 10B) (e.g., two switch circuits among the plurality of switches) included in a rectifier circuit (e.g., the rectifier circuit 230 in FIGS. 4A, 4B, and 7), based on a comparison of the voltage values at both ends of the coil by a comparison circuit (e.g., the comparison circuit 231 in FIGS. 4B, 7, 8A, 8B, 10A, and 10B) included in the rectifier circuit.

In operation 1205, the electronic device according to an embodiment may perform an operation of outputting, to a charging circuit (e.g., the charging circuit 251 in FIG. 3B) of the electronic device, power obtained by rectifying received wireless power by the rectifier circuit using at least two switches of the switch circuit, based on the enable signal.

When performing the operation of outputting the enable signal in operation 1203, the electronic device according to an embodiment, based on a first voltage value at one end (e.g., a first end) of the coil exceeding a second voltage value at the other end (e.g., a second end) of the coil, may output a first enable signal from a first comparator (e.g., the first comparator 231a in FIGS. 5A, 8A, and 10A) included in the comparison circuit by the rectifier circuit. When performing the operation of outputting the enable signal in operation 1205, the electronic device according to an embodiment, based on the second voltage value at the other end of the coil exceeding the first voltage value at one end of the coil, may output a second enable signal from a second comparator (e.g., the second comparator 231b in FIGS. 5A, 8B, and 10B) included in the comparison circuit by the rectifier circuit.

When performing the operation of outputting power obtained by rectifying wireless power in operation 1205, the electronic device according to an embodiment, under the control of the control circuit, may turn on the first switch and fourth switch of the switch circuit, and turn off the second switch and third switch of the switch circuit, based on the first enable signal. The electronic device may apply an output voltage to a regulator (e.g., the regulator 240 in FIG. 3B) connected to the charging circuit so as to transmit power to the charging circuit through the first switch and fourth switch, which are turned on, under the control of the control circuit.

When performing the operation of outputting power obtained by rectifying wireless power in operation 1205, the electronic device according to an embodiment, under the control of the control circuit, may turn on the second switch and third switch of the switch circuit and turn off the first switch and fourth switch of the switch circuit, based on the second enable signal. The electronic device may apply an output voltage to the regulator (e.g., the regulator 240 in FIG. 3B) connected to the charging circuit so as to transmit power to the charging circuit through the second switch and third switch, which are turned on, under the control of the control circuit.

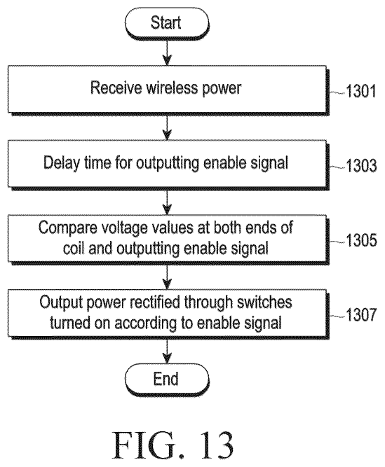

FIG. 13 is a drawing illustrating an example of an operation method in an electronic device according to an embodiment. In the following embodiments, the operations may be performed sequentially, but are not necessarily performed sequentially. For example, the sequence of the operations may be changed, and at least two operations may be performed in parallel.

Referring to FIG. 13, in operation 1301, an electronic device (e.g., the electronic device 101 in FIG. 1 and the electronic device 201 in FIGS. 2A, 2B, 3A, and 3B) according to an embodiment may connect to a transmission device (e.g., the external transmission device 301 in FIGS. 3A and 3B) using a short-range wireless communication scheme (e.g., NFC communication) for wireless charging. The electronic device may receive wireless power from the transmission device using the short-range wireless communication scheme via a coil (e.g., the coil 210 in FIG. 3B).

In operation 1303, the electronic device according to an embodiment may perform a time delay operation to forcibly disable (e.g., deactivate) an output terminal (enable pin) of the comparison circuit at an output time of an enable signal (e.g., an enable time of the output terminal), based on the operation timing of the rectifier circuit, and output the enable signal after delaying the enable signal by a specified time.

In operation 1305, the electronic device according to an embodiment may obtain voltage values at both ends of the coil by the control circuit, compare the voltage values at both ends of the coil by a comparison circuit (e.g., the comparison circuit 231 in FIGS. 4B, 7, 8A, 8B, 10A, and 10B) included in a rectifier circuit (e.g., the rectifier circuit 230 in FIGS. 4A, 4B, and 7), and output an enable signal to a switch circuit (e.g., the switch circuit 233 in FIGS. 4B, 7, 8A, 8B, 10A, and 10B) (e.g., two switch circuits among the plurality of switches) included in the rectifier circuit, under the control of the control circuit, based on the comparison result.

In operation 1307, the electronic device according to an embodiment may perform an operation of outputting, to a charging circuit (e.g., the charging circuit 251 in FIG. 4A) of the electronic device, power obtained by rectifying received wireless power by the rectifier circuit using at least two switches of the switch circuit, based on the enable signal.

When performing a time delay operation in the operation 1303, the electronic device according to an embodiment may apply, to the comparison circuit, a reference voltage adjusted to compensate for the transient time after the plurality of switches are turned on based on the reference voltage value by a voltage control circuit (e.g., the voltage control circuit 237 in FIGS. 10A and 10B) included in the rectifier circuit.

According to an embodiment, an operation method in an electronic device (e.g., the electronic device 201 in FIGS. 2A, 2B, 3A, and 4A) for wireless charging may include receiving wireless power from a transmission device (e.g., the transmission device 301 in FIG. 4B) using a coil 210 of the electronic device.

According to an embodiment, the method may include outputting an enable signal to at least two switches among a plurality of switches included in a rectifier circuit (e.g., the rectifier circuit 230 in FIGS. 4A, 4B, and 7) of the electronic device, based on a comparison of voltage values at both ends of the coil, by a comparison circuit (e.g., the comparison circuit 231 in FIGS. 4B, 7, 8A, 8B, 10A, and 10B) included in the rectifier circuit.

According to an embodiment, the method may include outputting power obtained by rectifying the wireless power to a charging circuit (e.g., the charging circuit 251 in FIG. 3B) of the electronic device using the two switches, based on the enable signal, by the rectifier circuit of the electronic device.

According to an embodiment, the outputting of the enable signal may include outputting, by the rectifier circuit, a first enable signal from a first comparator (e.g., the first comparator 231a in FIGS. 5A, 8A, and 10A) included in the comparison circuit when a first voltage value at one end of the coil exceeds a second voltage value at the other end of the coil.

according to an embodiment, the outputting of the power obtained by rectifying the wireless power may include turning on a first switch and a fourth switch among the plurality of switches and turning off a second switch and a third switch among the plurality of switches, based on the first enable signal, by the rectifier circuit, and applying an output voltage to the charging circuit through the first switch and the fourth switch by the rectifier circuit. According to an embodiment, the first switch may be electrically connected to the charging circuit, and the fourth switch may be electrically connected to ground.

According to an embodiment, the outputting of the enable signal may include outputting, by the rectifier circuit of the electronic device, a second enable signal from a second comparator (e.g., the second comparator 231b in FIGS. 5A, 8B, and 10B) included in the comparison circuit when a second voltage value at the other end of the coil exceeds a first voltage value at one end of the coil.

According to an embodiment, the outputting of the power obtained by rectifying the wireless power may include turning on a second switch and a third switch among the plurality of switches and turning off a first switch and a fourth switch among the plurality of switches, based on the second enable signal, by the rectifier circuit, and applying an output voltage to the charging circuit through the second switch and the third switch by the rectifier circuit. According to an embodiment, the second switch may be electrically connected to the charging circuit, and the third switch may be electrically connected to ground.

According to an embodiment, the method may further include outputting the enable signal by delaying the enable signal by a specified time by a discharge circuit (e.g., the discharge circuit 235 in FIG. 7) included in the rectifier circuit.

According to an embodiment, the method may further include compensating for a transient time after the plurality of switches are turned on, based on a reference voltage value, by a voltage control circuit (e.g., the voltage control circuit 237 in FIGS. 10A and 10B) included in the rectifier circuit. According to an embodiment, the voltage control circuit may be connected to the plurality of comparators.

In one or more embodiments of the present disclosure, an electronic device for wireless charging may include: a coil; a charging circuit; a rectifier circuit configured to rectify power that is wirelessly received from an external transmission device through the coil and output the rectified power to the charging circuit; a control circuit electrically connected to the rectifier circuit and the charging circuit. The rectifier circuit may include: a plurality of diodes; a switch circuit including a plurality of switches connected to the plurality of diodes; and a comparison circuit electrically connected to the coil and including at least one comparator configured to output an enable signal to the switch circuit based on a comparison of voltage values at both ends of the coil. The control circuit may be configured to control the rectifier circuit to output rectified power to the charging circuit using at least two switches among the plurality of switches based on the enable signal.

The rectifier circuit may be further configured to: based on a first voltage value of one end of the coil being greater than a second voltage value of another other end of the coil, output a first enable signal from a first comparator among a plurality of comparators included in the comparison circuit; based on the first enable signal, turn on a first switch and a fourth switch among the plurality of switches and turn off a second switch and a third switch among the plurality of switches; and apply a charging voltage to the charging circuit through the first switch and the fourth switch, wherein the first switch may be electrically connected to the charging circuit, and wherein the fourth switch may be electrically connected to ground.

The rectifier circuit may be further configured to: based on a second voltage value of one end of the coil being greater than a first voltage value of another end of the coil, output a second enable signal from a second comparator among a plurality of comparators included in the comparison circuit; based on the enable signal, turn on a second switch and a third switch among the plurality of switches and turn off a first switch and a fourth switch among the plurality of switches; and apply a charging voltage to the charging circuit through the second switch and the third switch, wherein the second switch may be electrically connected to the charging circuit, and wherein the third switch may be electrically connected to ground.

The rectifier circuit may further include a discharge circuit configured to output the enable signal after delaying output of the enable signal for a specified time. The discharge circuit may include a plurality of transistors. A first transistor of the plurality of transistors may be electrically connected to an enable pin of a first comparator of a plurality of comparators included in the comparison circuit and a first switch and a fourth switch among the plurality of switches. A second transistor of the plurality of transistors may be electrically connected to an enable pin of a second comparator of the plurality of comparators and a second switch and a third switch among the plurality of switches.

The rectifier circuit may further include a voltage control circuit, wherein the voltage control circuit may be electrically connected to the at least one comparator and may be configured to compensate for a transient time after turning on the plurality of switches based on a reference voltage value, and wherein the rectifier circuit may be configured to use a magnetic resonance method for wireless charging.

In one or more embodiments of the present disclosure, a rectifier included in an electronic device for wireless charging may include: a plurality of diodes; a switch circuit including a plurality of switches connected with the plurality of diodes; and a comparison circuit connected to a coil of the electronic device that receives wireless power from a transmission device and at least one comparator configured to output an enable signal to the switch circuit, based on a comparison of voltage values at both ends of the coil, wherein the switch circuit may be configured to turn on at least two switches among the plurality of switches, based on the enable signal, and output, to a charging circuit of the electronic device, power obtained by rectifying the wireless power using the two switches turned on.

The comparison circuit may be configured to output a first enable signal from a first comparator among a plurality of comparators included in the comparison circuit, based on a first voltage value at one end of the coil exceeding a second voltage value at another end of the coil. The switch circuit may be configured, based on the first enable signal, to turn on a first switch and a fourth switch among the plurality of switches and turn off a second switch and a third switch among the plurality of switches, thereby applying output charging voltage to the charging circuit through the first switch and the fourth switch.

The comparison circuit may be configured to output a second enable signal from a second comparator among a plurality of comparators included in the comparison circuit, based on a second voltage value at one end of the coil exceeding a first voltage value at another end of the coil. The switch circuit may be configured to, based on the second enable signal, turn on a second switch and a third switch among the plurality of switches and turn off a first switch and a fourth switch among the plurality of switches, thereby applying a charging voltage to the charging circuit through the second switch and the third switch.

The rectifier may include a discharge circuit configured to output the enable signal after delaying the enable signal by a specified time. The discharge circuit may include a plurality of transistors, wherein a first transistor among the plurality of transistors may be electrically connected to an enable pin of a first comparator among a plurality of comparators included in the comparison circuit and a first switch and a fourth switch among the plurality of switches, and wherein a second transistor among the plurality of transistors may be electrically connected to an enable pin of a second comparator among the plurality of comparators and a second switch and a third switch among the plurality of switches.

The rectifier may further include a voltage control circuit, and the voltage control circuit may be electrically connected to the at least one comparator and may be configured to compensate for a transient time after the plurality of switches are turned on, based on a reference voltage value.

In one or more embodiments of the present disclosure, an operation method in an electronic device for wireless charging, may include: receiving wireless power from a transmission device using a coil of the electronic device; outputting an enable signal to at least two switches among a plurality of switches included in a rectifier circuit of the electronic device, based on a comparison of voltage values at both ends of the coil, by a comparison circuit included in the rectifier circuit; and outputting power obtained by rectifying the wireless power to a charging circuit of the electronic device using the at least two switches, based on the enable signal, by the rectifier circuit of the electronic device.

The outputting of the enable signal may include outputting, by the rectifier circuit, a first enable signal from a first comparator included in the comparison circuit, based on a first voltage value at one end of the coil exceeding a second voltage value at another end of the coil. The outputting of the power obtained by rectifying the wireless power may include: turning on a first switch and a fourth switch among the plurality of switches and turning off a second switch and a third switch among the plurality of switches, based on the first enable signal, by the rectifier circuit; and applying a charging voltage to the charging circuit through the first switch and the fourth switch by the rectifier circuit. The first switch may be electrically connected to the charging circuit, and the fourth switch may be electrically connected to ground.

The outputting of the enable signal may include outputting, by the rectifier circuit of the electronic device, a second enable signal from a second comparator included in the comparison circuit, based on a second voltage value at one end of the coil exceeding a first voltage value at another end of the coil. The outputting of the power obtained by rectifying the wireless power may include: turning on a second switch and a third switch among the plurality of switches and turning off a first switch and a fourth switch among the plurality of switches, based on the second enable signal, by the rectifier circuit; and applying a charging voltage to the charging circuit through the second switch and the third switch by the rectifier circuit. The second switch may be electrically connected to the charging circuit, and the third switch may be electrically connected to ground.

The operation method may include: outputting the enable signal by delaying the enable signal by a specified time by a discharge circuit included in the rectifier circuit.

The operation method may include: compensating for a transient time after the plurality of switches are turned on, based on a reference voltage value, by a voltage control circuit included in the rectifier circuit, wherein the voltage control circuit may be connected to the comparison circuit.

The embodiments disclosed in this document may improve the efficiency of a rectifier in a wireless charging system using a magnetic resonance method for power charging. In addition, various other effects, which are directly or indirectly observed, may be provided through this document. The effects obtainable from this disclosure are not limited to the effects mentioned above, and other effects not mentioned will be clearly understood by those skilled in the art to which the disclosure pertains from the description below.

The embodiments disclosed in this document are presented for the purpose of explaining and understanding the disclosed technical concept and do not limit the scope of the technology described in this document. Therefore, the scope of this document should be interpreted to include all modifications and various other embodiments based on the technical concepts of this document.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device for wireless charging, the electronic device comprising:
a coil;
a charging circuit;
a rectifier circuit configured to rectify power that is wirelessly received from an external transmission device through the coil and output the rectified power to the charging circuit;
a control circuit electrically connected to the rectifier circuit and the charging circuit;
wherein the rectifier circuit comprises:
a plurality of diodes;
a switch circuit comprising a plurality of switches connected to the plurality of diodes; and
a comparison circuit electrically connected to the coil and comprising at least one comparator configured to output an enable signal to the switch circuit based on a comparison of voltage values at both ends of the coil, and
wherein the control circuit configured to control the rectifier circuit to output rectified power to the charging circuit using at least two switches among the plurality of switches based on the enable signal.

2. The electronic device of claim 1, wherein the rectifier circuit is further configured to:
based on a first voltage value of one end of the coil being greater than a second voltage value of another other end of the coil, output a first enable signal from a first comparator among a plurality of comparators included in the comparison circuit;
based on the first enable signal, turn on a first switch and a fourth switch among the plurality of switches and turn off a second switch and a third switch among the plurality of switches; and
apply a charging voltage to the charging circuit through the first switch and the fourth switch,
wherein the first switch is electrically connected to the charging circuit, and
wherein the fourth switch is electrically connected to ground.

3. The electronic device of claim 1, wherein the rectifier circuit is further configured to:
based on a second voltage value of one end of the coil being greater than a first voltage value of another end of the coil, output a second enable signal from a second comparator among a plurality of comparators included in the comparison circuit;
based on the enable signal, turn on a second switch and a third switch among the plurality of switches and turn off a first switch and a fourth switch among the plurality of switches; and
apply a charging voltage to the charging circuit through the second switch and the third switch,
wherein the second switch is electrically connected to the charging circuit, and
wherein the third switch is electrically connected to ground.

4. The electronic device of claim 1,
wherein the rectifier circuit further comprises a discharge circuit configured to output the enable signal after delaying output of the enable signal for a specified time,
wherein the discharge circuit comprises a plurality of transistors,
wherein a first transistor of the plurality of transistors is electrically connected to an enable pin of a first comparator of a plurality of comparators included in the comparison circuit and a first switch and a fourth switch among the plurality of switches, and
wherein a second transistor of the plurality of transistors is electrically connected to an enable pin of a second comparator of the plurality of comparators and a second switch and a third switch among the plurality of switches.

5. The electronic device of claim 1,
wherein the rectifier circuit further comprises a voltage control circuit,
wherein the voltage control circuit is electrically connected to the at least one comparator and is configured to compensate for a transient time after turning on the plurality of switches based on a reference voltage value,
wherein the rectifier circuit is configured to use a magnetic resonance method for wireless charging.

6. A rectifier included in an electronic device for wireless charging, the rectifier comprising:
a plurality of diodes;
a switch circuit comprising a plurality of switches connected with the plurality of diodes; and
a comparison circuit connected to a coil of the electronic device that receives wireless power from a transmission device and at least one comparator configured to output an enable signal to the switch circuit, based on a comparison of voltage values at both ends of the coil,
wherein the switch circuit is configured to turn on at least two switches among the plurality of switches, based on the enable signal, and output, to a charging circuit of the electronic device, power obtained by rectifying the wireless power using the two switches turned on.

7. The rectifier of claim 6,
wherein the comparison circuit is configured to output a first enable signal from a first comparator among a plurality of comparators included in the comparison circuit, based on a first voltage value at one end of the coil exceeding a second voltage value at another end of the coil, and
wherein the switch circuit is configured, based on the first enable signal, to turn on a first switch and a fourth switch among the plurality of switches and turn off a second switch and a third switch among the plurality of switches, thereby applying output charging voltage to the charging circuit through the first switch and the fourth switch.

8. The rectifier of claim 6,
wherein the comparison circuit is configured to output a second enable signal from a second comparator among a plurality of comparators included in the comparison circuit, based on a second voltage value at one end of the coil exceeding a first voltage value at another end of the coil, and
wherein the switch circuit is configured to, based on the second enable signal, turn on a second switch and a third switch among the plurality of switches and turn off a first switch and a fourth switch among the plurality of switches, thereby applying a charging voltage to the charging circuit through the second switch and the third switch.

9. The rectifier of claim 6,
further comprising a discharge circuit configured to output the enable signal after delaying the enable signal by a specified time,
wherein the discharge circuit comprises a plurality of transistors,
wherein a first transistor among the plurality of transistors is electrically connected to an enable pin of a first comparator among a plurality of comparators included in the comparison circuit and a first switch and a fourth switch among the plurality of switches, and
wherein a second transistor among the plurality of transistors is electrically connected to an enable pin of a second comparator among the plurality of comparators and a second switch and a third switch among the plurality of switches.

10. The rectifier of claim 6,
wherein the rectifier further comprises a voltage control circuit, and
wherein the voltage control circuit is electrically connected to the at least one comparator and is configured to compensate for a transient time after the plurality of switches are turned on, based on a reference voltage value.

11. An operation method in an electronic device for wireless charging, the operation method comprising:
receiving wireless power from a transmission device using a coil of the electronic device;
outputting an enable signal to at least two switches among a plurality of switches included in a rectifier circuit of the electronic device, based on a comparison of voltage values at both ends of the coil, by a comparison circuit included in the rectifier circuit; and
outputting power obtained by rectifying the wireless power to a charging circuit of the electronic device using the at least two switches, based on the enable signal, by the rectifier circuit of the electronic device.

12. The operation method of claim 11,
wherein the outputting of the enable signal comprises outputting, by the rectifier circuit, a first enable signal from a first comparator included in the comparison circuit, based on a first voltage value at one end of the coil exceeding a second voltage value at another end of the coil,
wherein the outputting of the power obtained by rectifying the wireless power comprises:
turning on a first switch and a fourth switch among the plurality of switches and turning off a second switch and a third switch among the plurality of switches, based on the first enable signal, by the rectifier circuit; and
applying a charging voltage to the charging circuit through the first switch and the fourth switch by the rectifier circuit, and
wherein the first switch is electrically connected to the charging circuit, and the fourth switch is electrically connected to ground.

13. The operation method of claim 11,
wherein the outputting of the enable signal comprises outputting, by the rectifier circuit of the electronic device, a second enable signal from a second comparator included in the comparison circuit, based on a second voltage value at one end of the coil exceeding a first voltage value at another end of the coil,
wherein the outputting of the power obtained by rectifying the wireless power comprises:
turning on a second switch and a third switch among the plurality of switches and turning off a first switch and a fourth switch among the plurality of switches, based on the second enable signal, by the rectifier circuit; and
applying a charging voltage to the charging circuit through the second switch and the third switch by the rectifier circuit, and
wherein the second switch is electrically connected to the charging circuit, and the third switch is electrically connected to ground.

14. The operation method of claim 11, further comprising:
outputting the enable signal by delaying the enable signal by a specified time by a discharge circuit included in the rectifier circuit.

15. The operation method of claim 11, further comprising:
compensating for a transient time after the plurality of switches are turned on, based on a reference voltage value, by a voltage control circuit included in the rectifier circuit,
wherein the voltage control circuit is connected to the comparison circuit.
